(19) United States
(12) Patent Application Publication
(10) Pub. No.: US 2015/0154774 A1
(43) Pub. Date: Jun. 4, 2015

(54) MEDIA RENDERING APPARATUS AND METHOD WITH WIDGET CONTROL

(71) Applicant: Telefonaktiebolaget LM Ericsson (publ), Stockholm (SE)

(72) Inventors: Johan Kölhi, Vaxholm (SE); Michael HUBER, Sundbyberg (SE)

(73) Assignee: Telefonaktiebolaget LM Ericsson (publ), Stockholm (SE)

(21) Appl. No.: 14/051,843

(22) Filed: Oct. 11, 2013

Related U.S. Application Data
(60) Provisional application No. 61/857,973, filed on Jul. 24, 2013.

(51) Int. Cl. G06T 11/60

(52) U.S. Cl. CPC G06T 11/60

(57) ABSTRACT

Method and apparatus are provided for intelligently rendering media with widget superimposition control. The method comprises determining a program characteristic/type of a program included in a receiving media stream, and controlling superimposition of a widget on a scene of the program in accordance with a widget superimposition rule. The widget superimposition rule is dependent on program characteristic/type to limit visual detraction of the widget from a predetermined content feature of the scene as the scene appears on a display device.

This application claims the priority and benefit of U.S. Provisional Patent Application 61/857,973 filed Jul. 24, 2013, entitled “MEDIA RENDERING APPARATUS AND METHOD WITH WIDGET CONTROL”, which is incorporated herein by reference in its entirety.

### TECHNICAL FIELD

The technology relates to method and apparatus for media rendering, and particularly the rendering of media in which a widget is inserted.

### BACKGROUND

Displaying widgets in front of a television image or other display is quite common. US Patent Publication US 2011/0154200 provides widgets that are “content aware” to the extent that the widgets present information pertinent to the content being presented by the television show, and which disappear when no longer relevant. State data for the widgets (e.g., corresponding to one or more of visibility/invisibility, activate/deactivate, change functionality, change appearance, and change position) is received by the media device in data packets together with the media content, thereby allowing the widgets to be controlled by the media content provider or other third party.

Running applications or widgets on top of a live television image may be a nice way of enriching the television experience. But inclusion of a widget for display in conjunction with a media stream can present problems. When a widget covers an important part of the video image, such as the face of a news anchor in a news program, for example, the widget may be annoying to the viewer.

### SUMMARY

In one of its aspects the technology disclosed herein concerns a method of rendering media. In a basic embodiment and mode the method comprises determining a program characteristic/type of a program included in a receiving media stream; and controlling superimposition of a widget on a scene of the program in accordance with a widget superimposition rule. The widget superimposition rule, implemented at the media rendering device, is dependent on program characteristic/type to limit visual detraction of the widget from a predetermined content feature of the scene as the scene appears on a display device.

Controlling superimposition of a widget on a scene of the program may take various forms. In one example embodiment and mode the method further comprises controlling location of the superimposition of the widget on the scene of the program in accordance with the widget superimposition rule. In an example implementation, the method further comprises waiting until expiration of a hysteresis time interval before changing the location of the superimposition of the widget on the scene of the program in accordance with the widget superimposition rule. In another example embodiment and mode the method further comprises controlling size of the superimposition of the widget on the scene of the program in accordance with the widget superimposition rule. In yet another example embodiment and mode the method further comprises controlling degree of transparency of the superimposition of the widget on the scene of the program in accordance with the widget superimposition rule.

In an example embodiment and mode the predetermined content feature of the scene is a human face. In an example embodiment and mode, the method further comprises detecting the human face in the scene.

The program characteristic/type may be determined in several ways. In a first example embodiment and mode the method further comprises using program metadata for determining the program characteristic/type. In a second example embodiment and mode the method further comprises using program guide/schedule information for determining the program characteristic/type. In a third example embodiment and mode the method further comprises using program content information for determining the program characteristic/type.

In an example embodiment and mode the method further comprises determining an available area for widgets in the scene based on the widget superimposition rule; determining a total consumption area for plural candidate widgets of the scene; and, if the available area is less than the total consumption area, excluding one or more of the plural candidate widgets from the scene based on a widget priority classification.

In an example embodiment and mode the widget superimposition rule is dependent on a viewing preference of an observer of the program.

In another of its aspects the technology disclosed herein concerns a media rendering device. The media rendering device comprises a program type detector and a processor. The program type detector is configured to determine a program characteristic/type of a program included in a receiving media stream. The processor is configured to control superimposition of a widget on a scene of the program in accordance with a widget superimposition rule. The widget superimposition rule is dependent on program characteristic/type to limit visual detraction of the widget from a predetermined content feature of the scene as the scene appears on a display device.

In an example embodiment the processor is further configured to control location of the superimposition of the widget on the scene of the program in accordance with the widget superimposition rule.

In an example embodiment the processor is further configured wait until expiration of a hysteresis time interval before changing the location of the superimposition of the widget on the scene of the program in accordance with the widget superimposition rule

In differing embodiments and modes the processor may control superimposition of a widget on a scene of the program in various ways. In a first example embodiment the processor is configured to control location of the superimposition of the widget on the scene of the program in accordance with the widget superimposition rule. In an example implementation the processor is further configured wait until expiration of a hysteresis time interval before changing the location of the superimposition of the widget on the scene of the program in accordance with the widget superimposition rule. In a second example embodiment the processor is further configured to control size of the superimposition of the widget on the scene of the program in accordance with the widget superimposition rule. In a third example embodiment the processor is further configured to control degree of transparency of the superimposition of the widget on the scene of the program in accordance with the widget superimposition rule.

In an example embodiment the predetermined content feature of the scene is a human face. In an example embodiment the media rendering device further comprises a feature detector configured to detect the human face in the scene.

In differing example embodiments the program type detector may determine the program characteristic/type in various or different ways. In a first example embodiment the program type detector is configured to use program metadata for determining the program characteristic/type. In a second example embodiment the program type detector is configured to use program schedule information for determining the program characteristic/type. In a third example embodiment the program type detector is configured to use program content information for determining the program characteristic/type.

In an example embodiment the processor is further configured to determine an available area for widgets in the scene based on the widget superimposition rule; determine an available area for widgets in the scene based on the widget superimposition rule; and if the available area is less than the total consumption area, exclude one or more of the plural candidate widgets from the scene based on a widget priority classification.

In an example embodiment the widget superimposition rule is dependent on a viewing preference of an observer of the program.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1A is a diagrammatic illustration of a display in which a face of a human is obscured by a widget; FIG. 1B-FIG. 1D are diagrammatic illustrations of a display in which superimposition display of a widget is controlled according to various example techniques of the technology disclosed herein, in accordance with a widget superimposition rule.

FIG. 2 is a diagrammatic view of an example embodiment of a display system comprising media rendering device which controls superimposition of a widget on a scene of the program displayed at a display device.

FIG. 3 is a flowchart depicting example acts or steps included in a basic, representative method of operating a media rendering device according to an example embodiment and mode.

FIG. 4A, FIG. 4B-1, FIG. 4B-2, and FIG. 4C are diagrammatic depictions of differing embodiments and modes by which program characteristic/type may be detected.

FIG. 5 is a diagrammatic view of another example embodiment of a media rendering device which utilizes input from a user/viewer for, e.g., widget superimposition control.

FIG. 6 is a flowchart illustrating example logic of a widget superposition controller for implementation of widget superimposition rules.

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks, including but not limited to those labeled or described as “computer”, “processor” or “controller”, may be provided through the use of hardware such as circuit hardware and/or hardware capable of executing software in the form of non-transient coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

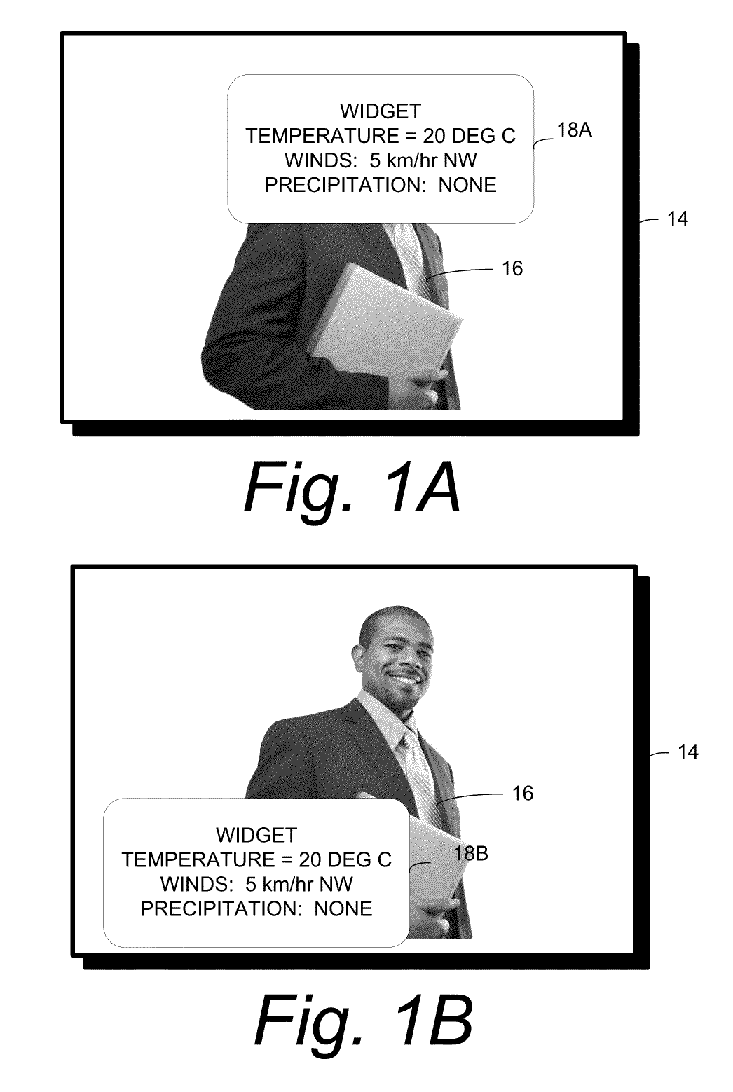

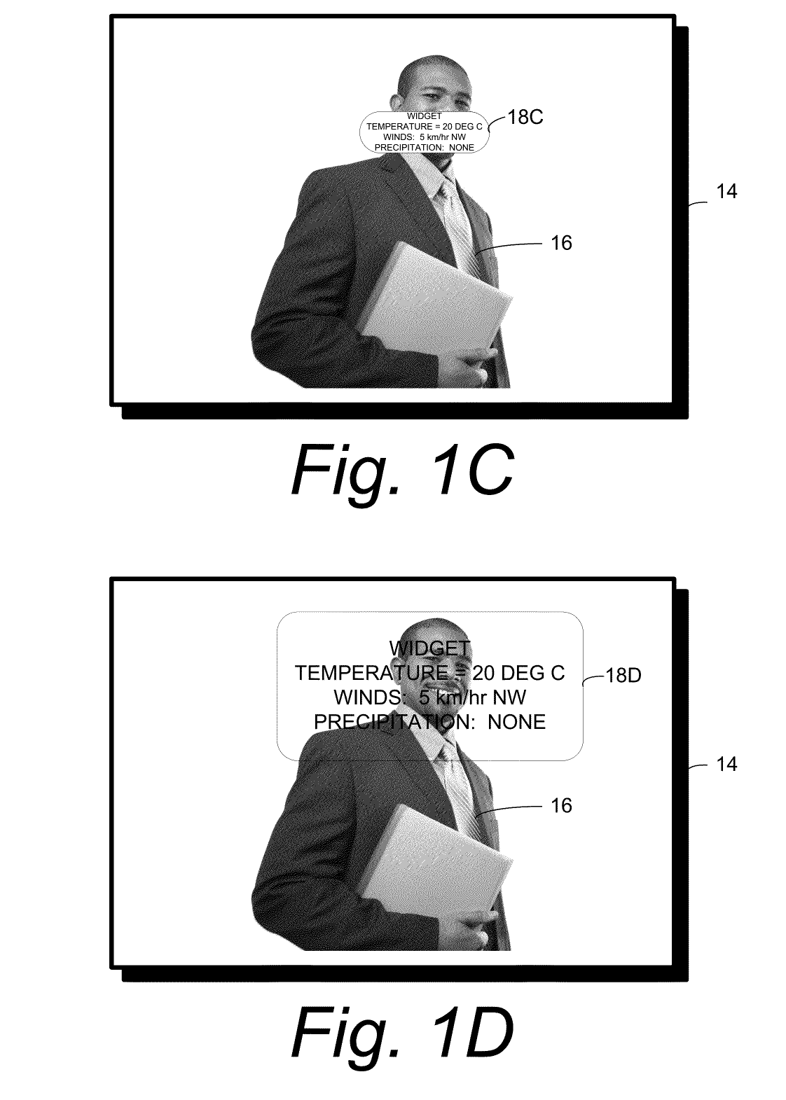

As discussed above, while widgets provide interesting and informative secondary information superimposed on a program scene of a display, the positioning of the widget may be such as to inappropriately or undesirably affect, e.g. visually obstruct, a content feature of a program scene appearing on a display device. See, for example, FIG. 1A wherein on a display device 14 a face of a human 16 is obscured by “weather” widget 18A. The technology disclosed herein concerns method and apparatus for controlling superimposition of a widget on a scene of the program, and preferably controlling the superimposition of the widget to limit visual detraction of the widget from a predetermined content feature of a scene depicted on a display device.

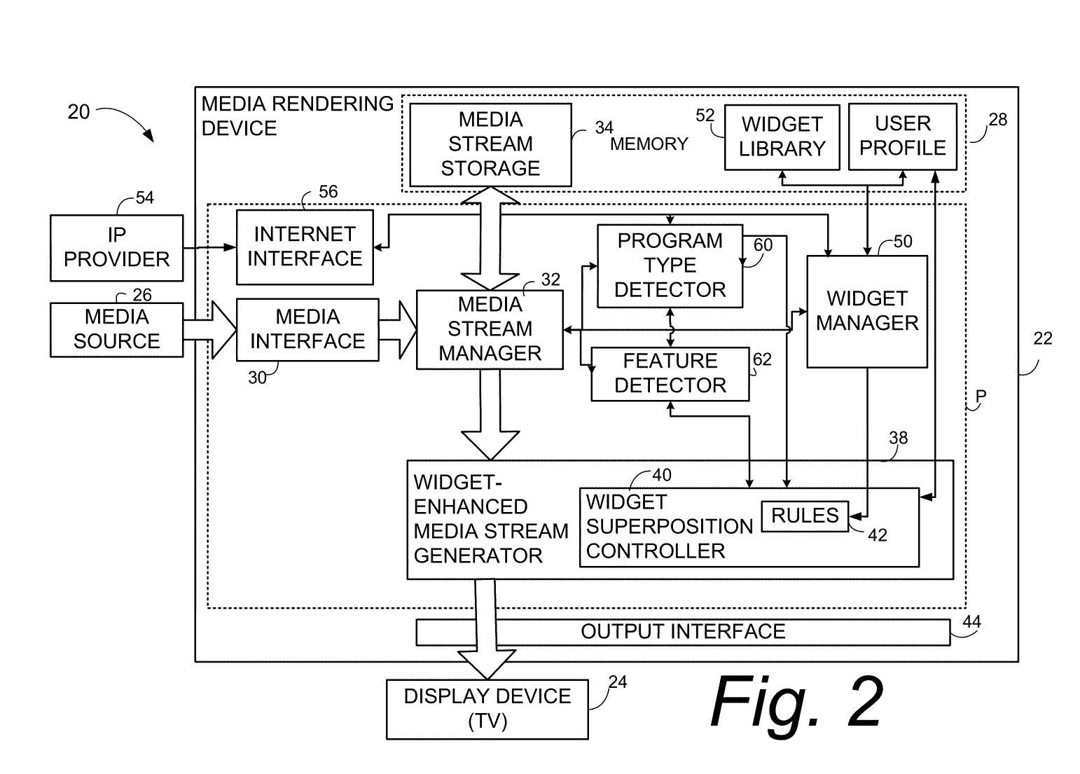

FIG. 2 illustrates a representative, example display system 20 comprising media rendering device 22 and display device 24. The media rendering device 22 may be any device that receives a media stream from a media source 26 and generates an enhanced media stream for display upon display device 24. An example of an enhanced media stream is a widget-enhanced media stream, e.g., a version of the media stream that is modified or adapted to include one or more widgets.

The media rendering device 22 may take the form of a set top box or set top unit, cable box, a satellite or microwave reception box, or any other appliance or device that receives a media stream and which delivers content of the media stream to a display device. The media rendering device 22 may comprise a tuner or connect to an external source of signal, turning the source signal into content in a form that can then be displayed on the display device 24.

The media source 26 may be an Ethernet cable, a satellite dish, a coaxial cable (e.g., for cable television), a telephone line (including DSL connections), broadband over power lines (BPL), or even an ordinary VHF or UHF antenna.

The display device 24 may be a monitor, television, or any other type of display, using any existing or hereinafter developed technology such as liquid crystal display, plasma display, cathode ray tube display, or other technology.

“Program”, or “program content” may include any or all of video, audio, Internet web pages, interactive video games, or other possibilities.

As used herein, a “widget” may be an element of a graphical user interface (GUI) that displays information or provides a specific way for a user to interact with an operating system or an application executed by a processor, such as a processor of the media rendering device 22. Widgets include icons, pull-down menus, buttons, selection boxes, progress indicators, on-off checkmarks, scroll bars, windows, window edges (that facilitate resizing of the window), toggle buttons, forms, and many other devices for displaying information and for inviting, accepting, and responding to user actions. Widgets may be used, for example, to display a stock ticker; display track sports scores; view photo galleries or videos, or view instant messages (SMS). Widgets are typically applications comprising computer-readable, non-transitory executable instruction which, when executed by a computer (e.g., on a processor), provide a graphical interface or widget display on display device 24. Some widgets are developed using one or more of HTML, XML and Javascript.

FIG. 2 further shows that, in a non-limiting example embodiment, media rendering device 22 comprises memory section 28; interfaces; detectors; and managers. A media interface 30 receives the incoming media stream from the media source 26 and conditions the incoming media stream for use by media stream manager 32. The media stream manager 32 serves to supervise storage of the media stream in media stream storage device 34 of memory section 28, as well as retrieval or readout of the media stream from 34 for application to widget-enhanced media stream generator 38. The widget-enhanced media stream generator 38 in turn comprises widget superposition controller 40 which superimposes a widget on a scene of the program of the media stream in accordance with one or more widget superimposition rules 42, thereby generating the widget-enhanced media stream. The widget-enhanced media stream is thereafter applied through output interface 44 to display device 24.

The incoming media stream may be stored by media stream manager 32 in media stream storage device 34 for essentially immediately readout, as when the media stream is being watched “live”. Alternatively, the incoming media stream may be stored by media stream manager 32 in media stream storage device 34 for later use, e.g., as may occur in recording a program for subsequent or delayed viewing.

The media rendering device 22 comprises widget manager 50 which, e.g., determines what particular widget(s) is/are to be displayed on display device 24 at any given time. At an appropriate time for use, widget manager 40 may access a particular widget either from widget library 52 maintained in memory section 28, or may obtain a widget from an external source such as the Internet. In this latter regard, FIG. 2 shows widget manager 50 being connected to an internet provider 54 through internet interface 56 of media rendering device 22. Widgets obtained from output interface 44 may be stored in widget library 52. What particular widget (obtained either from widget library 52, the internet, or elsewhere) is to be displayed may be determined based on several criteria. For example, the widget manager 50 is connected to media stream manager 32 to monitor the content of the media stream and to select an appropriate widget for display based on the content of the media stream as retrieved from media stream storage device 34 and applied to widget-enhanced media stream generator 38. Alternatively, and as discussed in more detail below, the widget manager 50 may determine what particular widget to display based on input provided by a user/viewer.

Superimposition of a widget on a scene of the program is controlled in accordance with one or more widget superimposition rules 42 to limit visual detraction of the widget from a predetermined content feature of the scene. The widget superimposition rules 42 are dependent on program characteristic/type of the incoming media stream. To this end, the media rendering device 22 comprises program type detector 60 which determines program characteristic/type of the incoming media stream. The program type detector 60 may determine the program characteristic/type in several ways in accordance with different embodiments, as described herein.

As mentioned above, in an example embodiment and mode media rendering device 22 controls superimposition of a widget on a scene of the program in accordance with a widget superimposition rule, dependent on program characteristic/type, to limit visual detraction of the widget from a predetermined content feature of the scene as the scene appears on a display device. To this end, media rendering device 22 comprises feature detector 62 which, like program type detector 60, is connected to media stream manager 32 so as to monitor the content of the media stream in search of a particular feature to be protected from widget detraction. Upon location or recognition of the protected feature, feature detector 62 notifies the widget superposition controller 40 of widget-enhanced media stream generator 38.

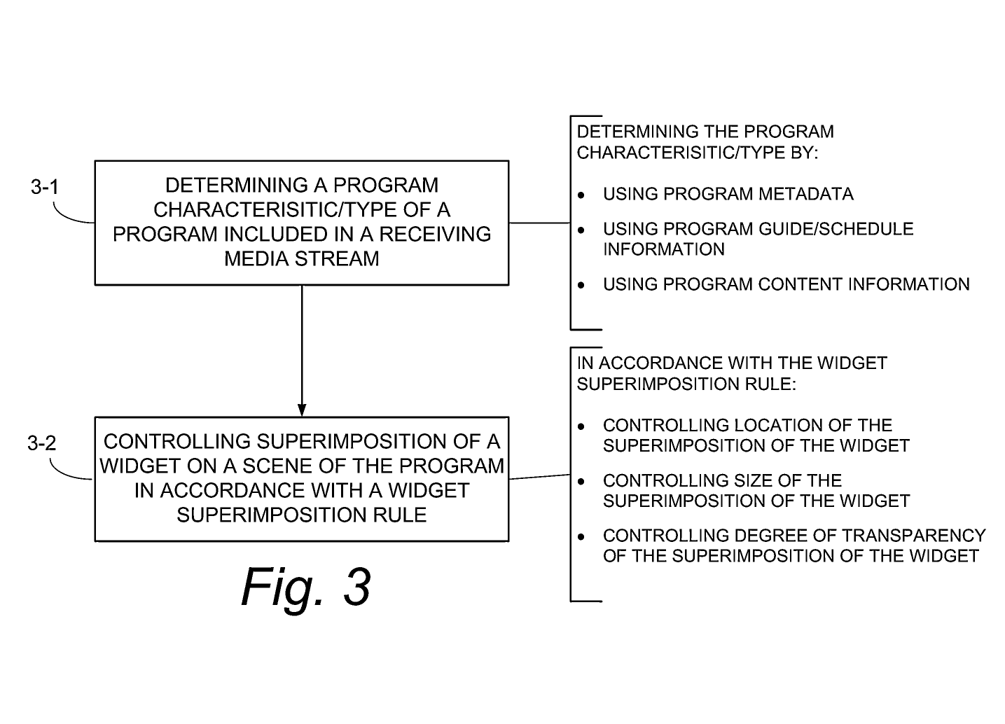

FIG. 3 illustrates example acts or steps included in a basic, representative method of operating a media rendering device according to an example embodiment and mode. Act 3-1 comprises determining a program characteristic/type of a program included in a receiving media stream. With reference to FIG. 2, the program characteristic/type of a program included in a receiving media stream is determined or detected by program type detector 60. Act 3-2 comprises controlling superimposition of a widget on a scene of the program in accordance with a widget superimposition rule. As mentioned above, the widget superimposition rule is dependent on program characteristic/type to limit visual detraction of the widget from a predetermined content feature of the scene as the scene appears on a display device. Again with reference to FIG. 2, superimposition of the widget on the scene of the program is controlled by widget superposition controller 40, in dependence upon widget superimposition rules 42.

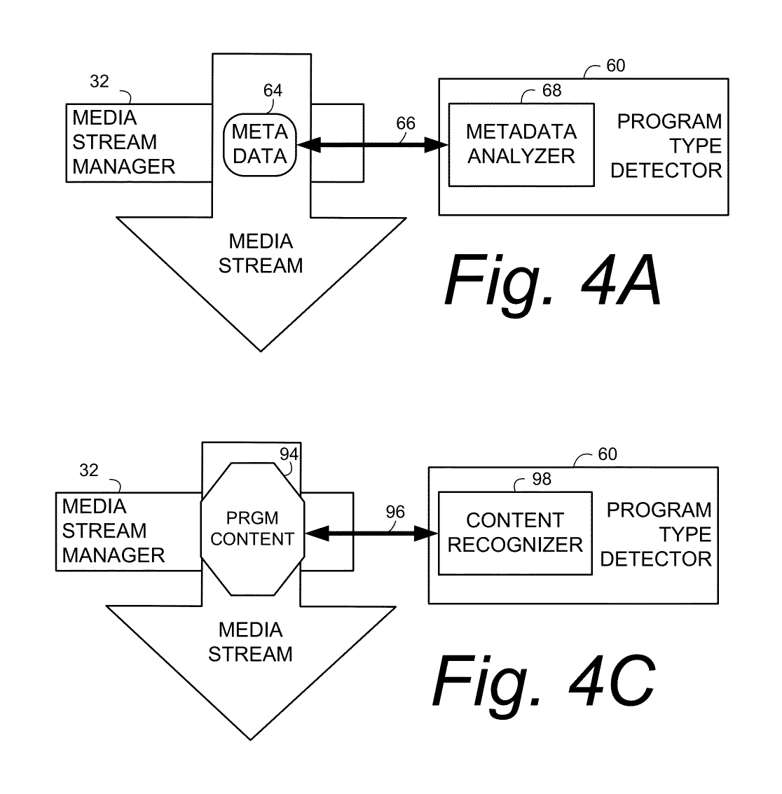

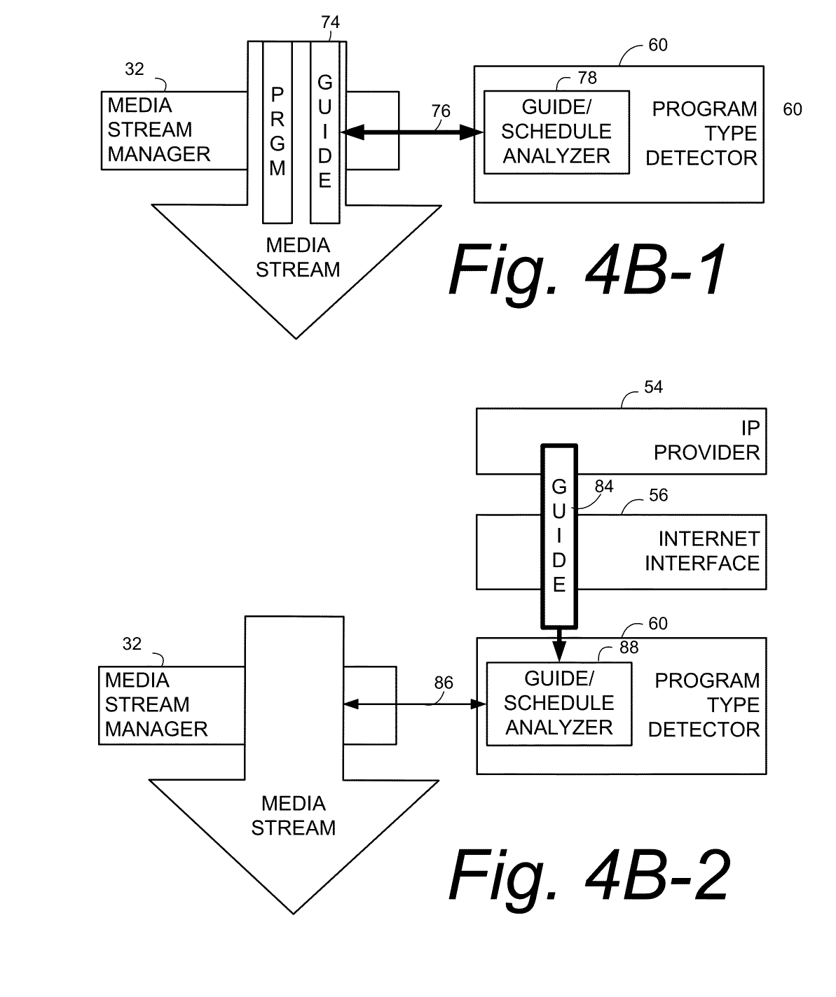

As further illustrated by FIG. 3, the program characteristic/type may be detected (e.g., by 60) in several ways in accordance with different embodiments and modes. In one example embodiment and mode, represented by FIG. 4A, the program characteristic/type is determined using program metadata. In another example embodiment and mode, represented by FIG. 4B-1 and FIG. 4B-2, the program characteristic/type is determined using program guide/schedule information. In a third example embodiment and mode, represented by FIG. 4C, the program characteristic/type is determined using program content information.

FIG. 4A illustrates an example embodiment and mode wherein the program type detector 60 uses program metadata to determine program characteristic/type. FIG. 4A shows that the media stream handled by media stream manager 32 includes metadata 64 that provides an indication of program characteristic/type. Arrow 66 of FIG. 4A depicts program type detector 60 monitoring the media stream for the metadata 64 and using the metadata 64 as input to its program characteristic/type logic. In this example embodiment program type detector 60 comprises metadata analyzer 68. Such program metadata tags that indicate program characteristic/type are already provided in some media streams, such as media streams fed to set top boxes, for example, and may be used to varying degree. Some such program metadata tags have been standardized. See, for example, ETSI TS 102 323 v1.3.1 (2008-04) “Digital Video Broadcasting, Carriage and signaling of TV-Anytime information in DVB transport streams.

The different types of program characteristic/types that may be indicated by the metadata tags 64 include, without limitation, the following: news programs; talk shows; movies; sports programs; children programs. The technology disclosed herein encompasses both program metadata tags, indicating program characteristic/type, that are fixed (e.g., by standard or convention or protocol of the media supplier) or are flexible. Examples of flexible program metadata tags include those which may comprise a blank field which can be subsequently completed and thus flexibly programmed by a service provider.

Thus, in an example embodiment, a metadata tag 64 in the metadata of the media stream may categorize the program type/characteristic of stream, but how to display the widget is decided locally by widget superposition controller 40. The metadata is input to media rendering device 22, and it is the media rendering device 22 itself that determines how to display the widget. Based on the type of metadata, the logic of the media rendering device 22 determines how the widget is to be handled.

FIG. 4B-1 illustrates one example embodiment and mode wherein the program type detector 60 uses program guide/schedule information which is carried in the media stream to determine program characteristic/type. FIG. 4B-1 specifically shows that program guide/schedule information is carried in a channel 70 of the media stream, the program guide/schedule channel 74 being one of plural channels including program channels carried by the media stream. The arrow 76 of FIG. 4B-1 depicts program type detector 60 of FIG. 4B-1 monitoring the media stream for the program guide/schedule channel 74 and using the program guide/schedule information as input to its program characteristic/type logic. In this example embodiment program type detector 60 comprises guide/schedule analyzer 78. In an example implementation of FIG. 4B-1 in which the media rendering device 22 is a cable box receiving a media stream from a cable television operator, the cable television operator may deliver the program guide as part of the media stream that is sent to the cable box. In other example embodiments of FIG. 4B-1 such as terrestrial television broadcasts, a separate channel may be employed as a separate guide channel which is included in a media stream comprising (including the guide channel).

FIG. 4B-2 illustrates one example embodiment and mode wherein the program type detector 60 uses program guide/schedule information which is obtained externally from the media stream to determine program characteristic/type. In the example of FIG. 4B-2, program guide/schedule information 84 is obtained from an external source such as internet provider 54 and applied to a guide/schedule analyzer 88 of program type detector 60. Knowing the current time, the program guide/schedule information 84, and the channel of the media stream (such knowledge depicted by arrow 86), the program type detector 60 can determine the program characteristic/type of the media stream currently handled by media stream manager 32 and applied to display device 24. In an example of the embodiment of FIG. 4B-2 the media source 26 of media rendering device 22 may comprise a tuner card or the like which receives television (TV) programs through the air, but the guide data comes externally such as from an Internet connection. The guide data is downloaded from an internet connection from a server which is run by a provider or an affiliate.

From FIG. 4B-1 and FIG. 4B-2 it should be understood that the manner of supply or of obtaining the program guide/schedule information may depend on the media stream supplier. Indeed, electronic programming guides can come in all different types of forms, and so in some example embodiments it may depend on who or what creates the guide. So in the guide/schedule modes of determining the program type/characteristic, there may be separate streams or separate sources of information: one stream being the program content data and the other stream being the program guide data. For example, the program guide comes from an entirely different source that is connected, e.g., to an Internet connection received through a separate port, and the media rendering device 22 syncs the two together and is able to discern the program type/characteristic.

FIG. 4C illustrates an example embodiment and mode wherein the program type detector 60 uses program content information to determine program characteristic/type. FIG. 4C depicts, by arrow 96, a content recognizer 98 that comprises program type detector 60 performing content recognition on program content 94 carried by the media stream. The content recognizer 98 may be programmed, either pre-programmed or programmed on the fly, to detect certain logos, emblems, persons, title, background information, in the media stream and on that basis deduce the type of characteristic of the program of the media stream currently being supplied by media rendering device 22 to display device 24. As an example implementation in which the content recognizer 98 uses the title of a show as the content information, the content recognizer 98 may recognize or search the title “TOP GEAR” as a title for an automobile car show, and upon such recognition the widget superposition controller 40 may apply a rule that view/user is not to be disturbed with a widget while watching this show. Alternatively, the content recognizer 98 may be trained or programmed to look for the logo “ESPN” in conjunction with a sports show, for example.

FIG. 3 also shows various ways or techniques for superposition of a widget. Techniques for controlling superposition of a widget include, for example, controlling location of the superimposition of the widget on the scene; controlling size of the superimposition of the widget on the scene; and controlling degree of transparency of the superimposition of the widget on the scene. Of course, another way, strategy, or technique of controlling superposition of the widget on the scene is to suppress display of the widget altogether.

As mentioned above, FIG. 1A shows a display device 14 displaying a face of a human 16 obscured by “weather” widget 18A. FIG. 1B-FIG. 1D, on the other hand, are diagrammatic illustrations of a display of the same human in which superimposition display of a widget is controlled according to various example of the technology disclosed herein in accordance with a widget superimposition rule.

In FIG. 1B the location of the superimposition of the widget on the scene is controlled so as to avoid visual detraction from the face of the human. In particular, widget 18B has been relocated to a position on the display device 14, e.g., the lower left hand corner, so that the face of the human 16 is not obscured.

In FIG. 1C the size of the superimposition of the widget on the scene is controlled so as to avoid visual detraction from the face of the human. In FIG. 1C the widget 18C has been reduced in size on the display device 14,

In FIG. 1D degree of transparency of the superimposition of the widget on the scene is controlled so as to avoid visual detraction from the face of the human. In particular, the transparency of the widget 18D has been increased so that the face of the human 16 is at least partially visible.

As mentioned above, superimposition of a widget on a scene is controlled in accordance with a widget superimposition rule, and such rule is dependent on program characteristic/type to limit visual detraction of the widget from a predetermined content feature of the scene. In the example display of FIG. 1A-FIG. 1D, such predetermined content feature is the face of the human 16.

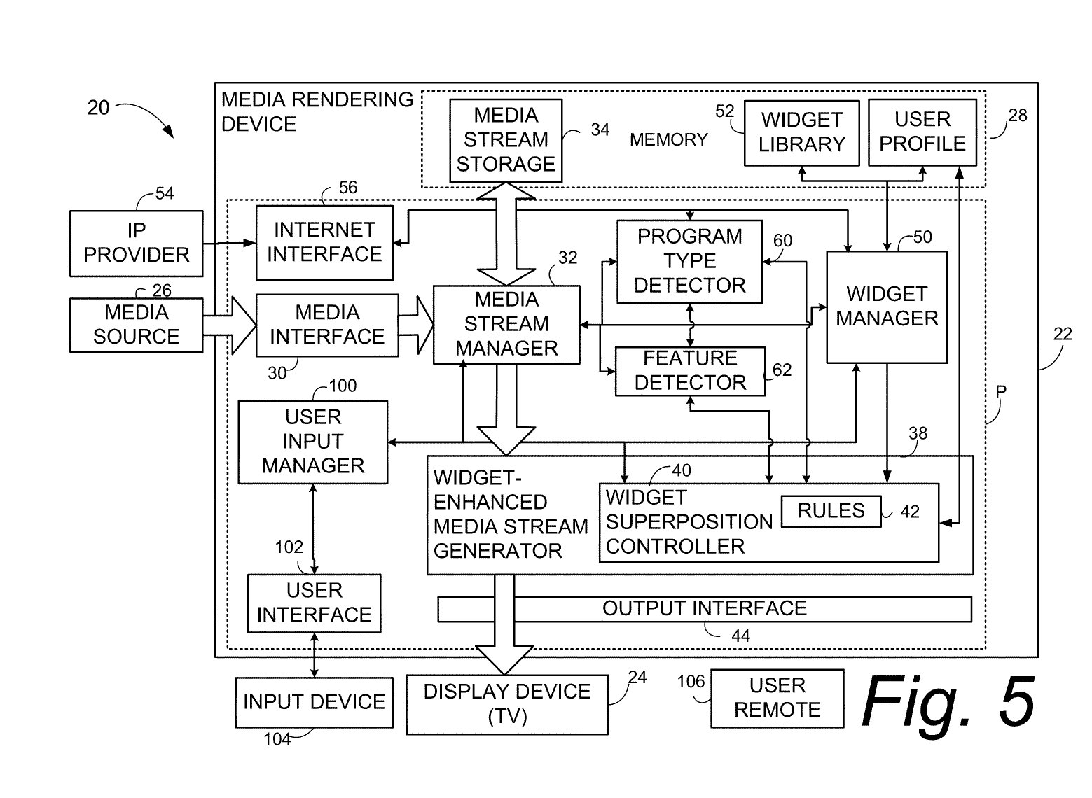

FIG. 5 illustrates a representative, example display system 20 comprising media rendering device 22 of another example embodiment wherein user/viewer input may also affect the widget superimposition, e.g., operation of widget-enhanced media stream generator 38 including configuration and implementation of widget superimposition rules 42. The media rendering device 22 of FIG. 5 includes all the elements and functionalities of FIG. 2, as well as additional elements and functionalities such as user input manager 100. The user input manager 100 is connected to user interface 102. The user interface 102 may itself receive input from a user/viewer, e.g., take the form of an on-board input device of the media rendering device 22 and thus receive input from the user/viewer as actuated by input buttons, touch-sensitive display, or the like. Alternatively or additionally, the user interface 102 may be connected by wire or cable to an external input device 104, such as a keyboard, and/or to a wireless or remote device, e.g., user remote control device 106.

User input, as received through any of user interface 102, external input device 104, and user remote control device 106, is processed by user input manager 100 and applied as appropriate to media interface 30, media stream manager 32, widget-enhanced media stream generator 38, and widget manager 50. The user input manager 100 thus may, as a result of user/viewer input, direct media interface 30 to turn on the media rendering device 22. Similarly, user input manager 100 may, as a result of user/viewer input, direct media interface 30 and/or media stream manager 32 to change channels, e.g., to change from one media stream to another media stream as provided by one or more media stream suppliers/sources.

The user input manager 100 is connected to widget manager 50 to enable the user/viewer to input (e.g., store) and/or command display of a certain widget. For example, using any of user interface 102, external input device 104, or user remote control device 106, the user/viewer may command widget manager 50 to obtain (e.g., internet provider 54) and store in widget library 52 a certain widget of interest to the user/viewer. For widgets already stored in widget library 52, or available on demand, using any of user interface 102, external input device 104, or user remote control device 106, the user/viewer may command widget manager 50 to display the certain widget. Of course, the widget to be displayed will be displayed according to the widget superimposition rules 42 as herein described.

The media rendering device 22 of FIG. 5 also comprises user profile 110. The user profile 110 may be located in memory section 28, and is accessible by, e.g., widget manager 50, user input manager 100, and widget-enhanced media stream generator 38 (including the widget superposition controller 40). In response to input received from the user/viewer through any of user interface 102, external input device 104, or user remote control device 106, the user input manager 100 may build in user profile 110 a record of the user/viewer's preferences for operation of the media rendering device 22. Such preferences as built and stored in user profile 110 may include information that may affect configuration and implementation of the widget superimposition rules 42. For example, in response to interrogatory from user input manager 100 or initiation by user/viewer, the user input manager 100 may collect input from the user/viewer regarding the user/viewer's preferences in regard to use and display of widgets. Based on such user/viewer input, the user input manager 100 may build the user profile 110, and the user profile 110 used as input for formation of widget superimposition rules 42 as implemented by widget superposition controller 40.

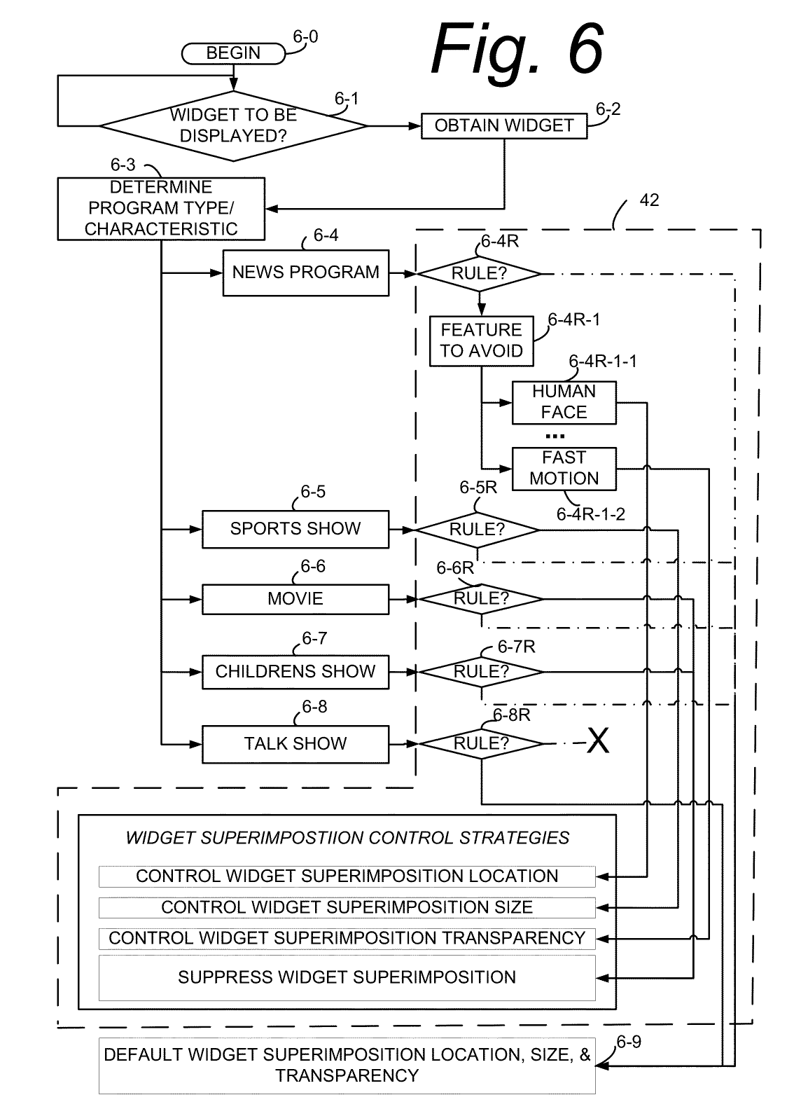

FIG. 6 shows an example of configuration and implementation of widget superimposition rules 42 in accordance with an example, representative, non-limiting scenario, in the context of selected aspects of overall operation of media rendering device 22. As such, FIG. 6 shows example, representative, non-limiting actions or steps of a method performed by media rendering device 22 in accordance with an example embodiment and mode of the technology disclosed herein. In FIG. 6 implementation of the widget superimposition rules 42 are reflected by the broken line that frames the rule-related actions. FIG. 6 shows only one example scenario of configuration of widget superimposition rules 42 in which the widget-enhanced media stream generator 38 inquires at various junctures whether the widget superimposition rules are in effect for a certain type of program type/characteristic. FIG. 6 shows by solid lines the actions which may be taken according to the widget superimposition rules 42 established for the example scenario of FIG. 6, but shows by dotted-dashed lines actions that are not taken (but otherwise would be taken if the widget superimposition rules 42 were not in effect).

Act 6-0 depicts beginning of the method. As act 6-1, widget manager 50 determines whether a widget is to be displayed at a current point in time. If a widget is not to be display at the current point in time, the widget manager periodically checks for any other indication that a widget is to be displayed, as indicated by the loop from a negative branch of act 6-1 back to the input of act 6-1.

The determination of whether a widget is to be displayed may depend on several factors, including any user input received from the user/viewer, including input received in essentially real time from any of user interface 102, external input device 104, and/or user remote control device 106. Alternatively the determination of whether a widget is to be displayed may depend on profile information stored in user profile 110, e.g., the user's preference or stored historical information that a certain widget be displayed in conjunction with a certain program or at a certain time.

If it is determined as action 6-2 that a widget is to be displayed, as act 6-3 the selected widget is obtained, e.g., either from an external source or from the widget library 52, for example. Once it has been determined that a particular widget is to be displayed and the widget has been obtained, as act 6-3 the widget superposition controller 40 obtains from program type detector 60 the program type/characteristic of the media stream now being directed from media stream storage device 34 to display device 24. The manner in which program type detector 60 makes its determination of the program type/characteristic is in accordance with the techniques described herein, including but not limited to those of FIG. 4A, FIG. 4B-1, FIG. 4B-2, and FIG. 4C.

Depending on the program type/characteristic as determined at act 6-3, the widget superposition controller 40 branches to an appropriate act for the determined program type. For example, if the determined program type is a news program, execution jumps to act 6-4; if the determined program type is a sports show, execution jumps to act 6-5; if the determined program type is a movie, execution jumps to act 6-6; if the determined program type is a childrens' show, execution jumps to act 6-7; if the determined program type is a talk show, execution jumps to act 6-8.

In the example embodiment and mode of FIG. 6, for each of the possible program types 6-X, as act 6-XR the widget superposition controller 40 checks whether rules of widget superimposition rules 42 have been established or invoked. The actions framed by broken line 42 of FIG. 6 show just one example scenario of such widget superimposition rules 42. In the example scenario, if there is no widget superimposition rule 42 associated with a particular program type/characteristic, the widget is inserted in the widget-enhanced media stream in a default manner: e.g., if with default superimposition location, size and transparency, as depicted by act 6-9 of FIG. 6.

In the example of FIG. 6, widget superimposition rules 42 have been established for each of news program 6-4, sports show 6-5, movie 6-6, and childrens' show 6-7. These rules may be either predefined or established by widget-enhanced media stream generator 38 itself, or may be based on user/viewer input as reflected by information received in essentially real time from the user/viewer or stored in the user profile 110.

In fact that widget superimposition control rules 42 have indeed been instigated for each of news program 6-4, sports show 6-5, movie 6-6, and childrens' show 6-7, is reflected by the solid decision line result taken from each of rule invocation inquiries 6-4R (news program), 6-5R (sports show), 6-6R (movie), and 6-7R (childrens' show). Had the widget superimposition rules 42 not been in effect, the dashed-dotted decision line would instead be taken to the default action 6-9.

The rules applied for the news program 6-4 further illustrate that the widget superposition controller 40 may be requested or programmed to avoid a certain predetermined content feature of a scene as the scene is to appear on display device 24. In this regard, the widget superposition controller 40 checks as act 6-4R-1 whether the widget superimposition rules 42 include designation of a particular feature to avoid. In the example scenario it so happens that two feature avoidance rules have been included in widget superimposition rules 42 for the news program type/characteristic.

A first feature avoidance rule (act 6-4R-1-1) for the news program type/characteristic of FIG. 6 concerns a human face which may appear as the predetermined content feature of a scene of the news program. As indicated by the arrow emanating from first feature avoidance rule (act 6-4R-1-1), the widget superimposition control strategy may be pre-arranged or otherwise specified with respect to a human face to control the location of the widget superimposition, e.g., to move the widget to an alternate location (e.g., a location of than the location where the human face is detected). Such movement or re-location of the widget is understood, for example, with reference to FIG. 1B. The location of the human face on the screen may be ascertained by the feature detector 62, which may be commanded by widget superposition controller 40 to provide the coordinates or location of the specified predetermined content feature (e.g., the human face). Such face recognition techniques and algorithms as implemented in feature detector 62 are well known, having been utilized in cameras and other devices and/or appliances as well.

While relocation of the widget may be beneficial, the widget superposition controller 40 may be configured to wait until expiration of a hysteresis time interval before changing the location of the superimposition of the widget on the scene of the program in accordance with the widget superimposition rule. This is to avoid relocating the widget too quickly, which may result in visual confusion and/or unwisely utilize processing resources.

It should be understood that another of the widget superimposition control strategies could alternatively or additionally have been implemented. For example, instead of relocating the widget from the human face in the manner of FIG. 1B, the transparency of the widget would be increased in the manner of FIG. 1D. Any one or more widget superimposition strategies may be utilized, and plural widget superimposition strategies may be utilized in combination (e.g., both relocation and increased transparency of the widget).

A second feature avoidance rule (act 6-4R-1-2) for the news program type/characteristic of FIG. 6 concerns a fast motion scene which may appear as the predetermined content feature of a scene of the news program. A fast motion scene may be detected by feature detector 62 as a quickly changing background in a scene in which a police car is in speedy pursuit, for example.

As indicated by the arrow emanating from second feature avoidance rule (act 6-4R-1-2), the widget superimposition control strategy may be pre-arranged or otherwise specified with respect to the fast motion scene to control the superposition transparency of the widget, e.g., to make the widget more transparent so that more of the scene can be shown through the widget. Increase in transparency of a widget is illustrated in the manner of FIG. 1D, for example (albeit with reference to a human face and not a fast motion scene). Again, other or a combination of widget superimposition control strategies may be employed.

FIG. 6 further detects implementation of widget superimposition rules 42 for each of the sports show 6-5, movie 6-6, and childrens' show 6-7. In the case of sports show 6-5, the applicable widget superimposition control strategy is to control (e.g., reduce) the size of the superimposed widget. For both the movie 6-6 and the childrens' show 6-7, the applicable widget superimposition control strategy is to suppress the widget altogether. Of course, another widget superimposition control strategy may instead be employed, depending, e.g., on user/viewer preference. But in the situation in which widget suppression results, the widget superposition controller 40 may be programmed or otherwise ordered so that any widget which might be displayed during the motion picture or children's program may be pushed or delayed until the end of the motion picture or children's program.

In example embodiments such as those of FIG. 2 and FIG. 6, functionalities of media rendering device 22 may be realized using electronic circuitry. For example, FIG. 2 and FIG. 6 depict by broken line P various units or functionalities that may be realized by electronic circuitry and particularly by machine platform, the platform P. The terminology “platform” is a way of describing how the functional units of the packet core network entity can be implemented or realized by machine including electronic circuitry. One example platform P is a computer implementation wherein one or more of the broken line framed elements of media rendering device 22 are realized by one or more processors which execute coded instructions stored on non-transient computer/processor-readable memory and which use non-transitory signals in order to perform the various acts described herein. In such a computer implementation the memory section 28 may comprise random access memory; read only memory; application memory (which stores, e.g., coded instructions which can be executed by the processor to perform acts described herein); and any other memory such as cache memory, for example.

In some example embodiments the platform P for the media rendering device 22 may also comprise other input/output units or functionalities, such as keypad; audio input device (e.g. microphone); visual input device (e.g., camera); visual output device; and audio output device (e.g., speaker).

In addition to computer-implemented or computer-based platforms, another example platform suitable for the media rendering device 22 is that of a hardware circuit, e.g., an application specific integrated circuit (ASIC) wherein circuit elements are structured and operated to perform the various acts described herein, or a circuit otherwise fabricated, e.g., from silicon.

Thus, in the media rendering device 22 of the technology disclosed herein the logic for controlling the superimposition of a widget is stored at and performed by the media rendering device 22, and not dictated upstream by content of media itself.

From the foregoing it can be seen that the technology disclosed herein involves, in at least some of its aspects, determining program type for a program currently being show, and displaying at least one widget using a rule, the rule be selected according to the determined program type. One example way of determining the program type is reading program metadata; another way is to look at guide data, another way is to apply a content type recognition algorithm to the video.

As an example, when program metadata indicates that a news program is being shown, the rule may be applied that widgets should not cover the presenters' faces. Face detection algorithms analyzing the TV image in real time are applied. These can detect a face of a news anchor and modify the placement of the widgets, as discussed above. Active face detection running on the TV stream detects faces and selects various methods to solve the problem. For example, position of the widget on the screen can change, so it moves to a place on the screen where no face exist at the moment, as illustrated by FIG. 1B. Alternatively, a widget can temporarily hide itself while a face is in its position.

The size of the widget can change, so it becomes a lot smaller, as illustrated by FIG. 1C. Or, a user/viewer may set a priority of widget display such that certain widgets have a minimum transparency as illustrated by FIG. 1D. Widget transparency can be set to a high number, so a vague shadow only is visible of the widget or application. (Like 5-10% visibility or similar).

Further, the user can set a widget display order priority, such that if a rule determines the screen area available for widgets is less than the current widget area, the least important widgets are dropped.

Any combination of the above can be done, other means of hiding/moving out of the way can be done as well.

In terms of content recognition or feature detection, motion detection and other algorithms may complement the face detection algorithm to broaden the use of the widget superimposition control. These additional algorithms can detect and differentiate between cars followed by the camera while the background is blurry and slow panoramic movement.

Some example embodiments may employ machine learning algorithms to detect a scene and know from previous viewer behavior what the viewer preferences may be, and apply such viewer preference proactively to future occurrences of the same type of media stream. These machine learning algorithms may combine input from video frames and how the viewer presses the buttons on the remote. For example, a viewer may not mind that parts of the video is covered, or perhaps another viewer does not want any disturbance while motion or faces are detected.

The different algorithms may be enabled/disabled by different profiles. These profiles may automatically be selected by metadata sent in the media stream to the media rendering device 22.

A stream tagged as “NEWS” (e.g., news program) may select a NEWS-profile that, as an example, contains a face detection mechanism. The profile moves the widgets on screen so that they are not in front of any faces on display. To prevent repeated shuffling of widgets-which would be more annoying to a user, hysteresis may be applied so that the widgets are not reshuffled for 6 seconds. During that 6 seconds widgets covering a face will be made at least partially transparent. This addresses switching between two news casters, each displayed on different sides of the screen, and it also addresses the problem of the video switching to reports from other locations.

While some example program types and widget superimposition control strategies have been described above. Others are also possible. For example, for an “entertainment” show widgets made semi transparent in response to face recognition and hidden in response to text recognition (useful for telephone voting programs). For “documentary” programs all widgets may be made partially transparent. There may be a program type “sport-general” for which all widgets are off by default to allow for onscreen graphics typically present. On the other hand, there may also be another program type of “sport-specific” in which widgets specific to the identified sporting event are displayed (e.g., Formula 1 or Olympics coverage may be identified from the guide as well as tags).

In general, the technology disclosed herein facilitates placing widgets on a screen or display in a way appropriate to the content playing at the time. For example, a widget should not cover a news-casters face, thereby reducing overall annoyance to the viewer.

The technology disclosed herein may be implemented on window manager level, so all existing applications and widgets can make use thereof. No applications or widgets needs to be modified in such case. The technology disclosed herein may also be implemented on an application by application basis, using APIs or common libraries to achieve the same thing.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method of rendering media comprising:
determining a program characteristic/type of a program included in a receiving media stream;
controlling superimposition of a widget on a scene of the program in accordance with a widget superimposition rule, the widget superimposition rule being dependent on program characteristic/type to limit visual detraction of the widget from a predetermined content feature of the scene as the scene appears on a display device.

2. The method of claim 1, further comprising controlling location of the superimposition of the widget on the scene of the program in accordance with the widget superimposition rule.

3. The method of claim 1, further comprising waiting until expiration of a hysteresis time interval before changing the location of the superimposition of the widget on the scene of the program in accordance with the widget superimposition rule.

4. The method of claim 1, further comprising controlling size of the superimposition of the widget on the scene of the program in accordance with the widget superimposition rule.

5. The method of claim 1, further comprising controlling degree of transparency of the superimposition of the widget on the scene of the program in accordance with the widget superimposition rule.

6. The method of claim 1, wherein the predetermined content feature of the scene is a human face.

7. The method of claim 6, further comprising detecting the human face in the scene.

8. The method of claim 1, further comprising using program metadata for determining the program characteristic/type.

9. The method of claim 1, further comprising using program guide/schedule information for determining the program characteristic/type.

10. The method of claim 1, further comprising using program content information for determining the program characteristic/type.

11. The method of claim 1, further comprising:
determining an available area for widgets in the scene based on the widget superimposition rule;
determining a total consumption area for plural candidate widgets of the scene;
if the available area is less than the total consumption area, excluding one or more of the plural candidate widgets from the scene based on a widget priority classification.

12. The method of claim 1, further comprising the widget superimposition rule being dependent on a viewing preference of an observer of the program.

13. A media rendering device comprising:
a program type detector configured to determine a program characteristic/type of a program included in a receiving media stream;
a processor configured to control superimposition of a widget on a scene of the program in accordance with a widget superimposition rule, the widget superimposition rule being dependent on program characteristic/type to limit visual detraction of the widget from a predetermined content feature of the scene as the scene appears on a display device.

14. The media rendering device of claim 13, wherein the processor is further configured to control location of the superimposition of the widget on the scene of the program in accordance with the widget superimposition rule.

15. The media rendering device of claim 13, wherein the processor is further configured wait until expiration of a hysteresis time interval before changing the location of the superimposition of the widget on the scene of the program in accordance with the widget superimposition rule.

16. The media rendering device of claim 13, wherein the processor is further configured to control size of the superimposition of the widget on the scene of the program in accordance with the widget superimposition rule.

17. The media rendering device of claim 13, wherein the processor is further configured to control degree of transparency of the superimposition of the widget on the scene of the program in accordance with the widget superimposition rule.

18. The media rendering device of claim 13, wherein the predetermined content feature of the scene is a human face.

19. The media rendering device of claim 18, further comprising a feature detector configured to detect the human face in the scene.

20. The media rendering device of claim 13, wherein the program type detector is configured to use program metadata for determining the program characteristic/type.

21. The media rendering device of claim 13, wherein the program type detector is configured to use program guide/schedule information for determining the program characteristic/type.

22. The media rendering device of claim 13, wherein the program type detector is configured to use program content information for determining the program characteristic/type.

23. The media rendering device of claim 13, wherein the processor is further configured to:
determine an available area for widgets in the scene based on the widget superimposition rule;
determine an available area for widgets in the scene based on the widget superimposition rule;
if the available area is less than the total consumption area, exclude one or more of the plural candidate widgets from the scene based on a widget priority classification.

24. The media rendering device of claim 13, wherein the widget superimposition rule is dependent on a viewing preference of an observer of the program.
